(19) United States
(12) Patent Application Publication
(10) Pub. No.: US 2026/0095419 A1
(43) Pub. Date: Apr. 2, 2026

(54) METHOD AND SYSTEM FOR RESOURCE ALLOCATION USING REINFORCEMENT LEARNING

(71) Applicant: Telefonaktiebolaget LM Ericsson (publ), Stockholm (SE)

(72) Inventors: Carla MOURADIAN, Montreal (CA); Fetahi WUHIB, Pincourt (CA)

(73) Assignee: Telefonaktiebolaget LM Ericsson (publ), Stockholm (SE)

(21) Appl. No.: 19/113,093

(22) PCT Filed: Sep. 22, 2022
(86) PCT No.: PCT/IB2022/058976

§ 371 Date: Mar. 19, 2025

(51) Int. Cl. H04L 47/70; H04L 41/122; H04L 41/16; H04L 41/40

(52) U.S. Cl. CPC H04L 47/829; H04L 41/122; H04L 41/16; H04L 41/40

(57) ABSTRACT

Embodiments include solutions to allocate resources using Markov Decision Processes (MDPs). An exemplary method comprises: receiving a service topology to provide a plurality of services that are interdependent; receiving a performance target for each service; and applying a set of MDPs to the service topology and the performance targets to derive resource allocation to achieve the performance targets, each of the set of MDPs being defined by: a state space including a plurality of states, each state represented by a resource allocation of each of the plurality of services, performance of each of the plurality of services at the each state, and a dependency relationship among the plurality of services; an action space represented by a set of actions that change a resource allocation; a reward function that calculates numeric scores for the plurality of services, and a probability space represented by probabilities to transition.

### TECHNICAL FIELD

Embodiments of the invention relate to the field of resource allocation and more specifically, to resource allocation using reinforcement learning.

### BACKGROUND ART

Network Function Virtualization (NFV) has emerged as a revolutionary paradigm for communication networks. By decoupling Network Functions (NF) and dedicated hardware, NFV allows NFs to evolve independently from hardware, thus leading towards reduced capital and operational expenditure (CAPEX/OPEX). In NFV, services are composed of one or more VNFs connected in a specific order to create a Service Function Chain (SFC) or a more general graph topology, which is known as Virtual Network Function-Forwarding Graph (VNF-FG), supporting the service. Each VNF in the SFC or VNF-FG requires a set of resources to process the traffic passing through it. In cloud computing, a similar concept can be found in microservices whereby an application is composed of a set of microservices that interact with each other to implement the functionality of the application.

Multiple VNFs and microservices may be interdependent to support services/applications. The interdependency is shown in a VNF-FG for the VNFs, and in a microservice dependency graph for microservices. For example, VNFs may share the same underlying network node (also referred to as network device) and may vie for the same resources when processing the traffic passing through them. Existing resource configuration solutions rely on static-model-based resource allocation or estimate the resource configurations of stand-alone VNFs or microservices, while ignoring the interdependency of VNFs or microservices. In addition, they consider homogenous infrastructure resources (e.g., computing resources such as central processing unit (CPU) consideration).

It thus remains challenging to allocate resources to VNFs in a Virtual Network Function-Forwarding Graph (VNF-FG) to achieve expected performance of the VNFs, considering the interdependency of the VNFs, and the challenges multiply when a network includes VNFs assigned to multiple service function chains in the network. For similar reasons, allocating resources to microservices is challenging considering the interdependency of the microservices.

### SUMMARY OF THE INVENTION

Embodiments include methods, electronic device, storage medium, and computer program to allocate resources using Markov Decision Processes. In one embodiment, a method comprises: receiving a service topology to provide a plurality of services included in the service topology for implementing an application in the network, the plurality of services being interdependent to implement the application; receiving a performance target for each of the plurality of services in the service topology; and applying a set of Markov Decision Processes to the service topology and the performance targets to derive resource allocation of each of the plurality of services to achieve the performance targets for the plurality of services, each of the set of Markov Decision Processes being defined by: a state space including a plurality of states, each state represented by a resource allocation of each of the plurality of services, performance of each of the plurality of services at the each state, and a dependency relationship among the plurality of services; an action space represented by a set of actions that change a resource allocation of the plurality of services; a reward function that calculates numeric scores for the plurality of services, each numeric score for a service of the plurality of services being computed based on the service's current performance, performance target, and dependency of the service to other services of the plurality of services, and a probability space represented by probabilities to transition, each transition being from a first state to a second state of the plurality of states.

In one embodiment, an electronic device comprises a processor and machine-readable storage medium that provides instructions that, when executed by the processor, are capable of causing the processor to perform: receiving a service topology to provide a plurality of services included in the service topology for implementing an application in the network, the plurality of services being interdependent to implement the application; receiving a performance target for each of the plurality of services in the service topology; and applying a set of Markov Decision Processes to the service topology and the performance targets to derive resource allocation of each of the plurality of services to achieve the performance targets for the plurality of services, each of the set of Markov Decision Processes being defined by: a state space including a plurality of states, each state represented by a resource allocation of each of the plurality of services, performance of each of the plurality of services at the each state, and a dependency relationship among the plurality of services; an action space represented by a set of actions that change a resource allocation of the plurality of services; a reward function that calculates numeric scores for the plurality of services, each numeric score for a service of the plurality of services being computed based on the service's current performance, performance target, and dependency of the service to other services of the plurality of services, and a probability space represented by probabilities to transition, each transition being from a first state to a second state of the plurality of states.

In one embodiment, a machine-readable storage medium that provides instructions that, when executed by a processor, are capable of causing the processor to perform: receiving a service topology to provide a plurality of services included in the service topology for implementing an application in the network, the plurality of services being interdependent to implement the application; receiving a performance target for each of the plurality of services in the service topology; and applying a set of Markov Decision Processes to the service topology and the performance targets to derive resource allocation of each of the plurality of services to achieve the performance targets for the plurality of services, each of the set of Markov Decision Processes being defined by: a state space including a plurality of states, each state represented by a resource allocation of each of the plurality of services, performance of each of the plurality of services at the each state, and a dependency relationship among the plurality of services; an action space represented by a set of actions that change a resource allocation of the plurality of services; a reward function that calculates numeric scores for the plurality of services, each numeric score for a service of the plurality of services being computed based on the service's current performance, performance target, and dependency of the service to other services of the plurality of services, and a probability space represented by probabilities to transition, each transition being from a first state to a second state of the plurality of states.

Embodiments of the invention allocate resources to services in a service topology to achieve performance targets with consideration of the interdependency of the services. They can handle applications implemented through the service topology with required performance targets. They provide generic solution that can generate a resource allocation for various expected/target performances and for large number of service topologies with various interdependencies between services

### BRIEF DESCRIPTION OF THE DRAWINGS

The invention may best be understood by referring to the following description and accompanying drawings that are used to illustrate embodiments of the invention. In the drawings:

FIG. 1 illustrates service interdependency in a service topology.

FIG. 2 illustrates resource allocation based on Markov Decision Processes per some embodiments.

FIG. 3 illustrates multi-agent reinforcement learning (MARL) for resource allocation per some embodiments.

FIG. 4 is a flow diagram illustrating the operations to generate reinforcement models that provide resource allocation for service topologies with different dependencies per some embodiments.

FIG. 5 is a flow diagram illustrating the operations to create the minimum number of sets of services per some embodiments.

FIG. 6 is a flow diagram illustrating the operations to a reinforcement agent to automatically generate resource allocation for any performance target per some embodiments.

FIG. 7 is a flow diagram illustrating the operations to identify a model to use for a service topology per some embodiments.

FIG. 8 is a flow diagram illustrating the operations to provide resource allocation for a service topology per some embodiments.

FIG. 9 illustrates an electronic device implementing adaptive fault remediation per some embodiments.

FIG. 10 illustrates an example of a communication system per some embodiments.

FIG. 11 illustrates a UE per some embodiments.

FIG. 12 illustrates a network node per some embodiments.

FIG. 13 is a block diagram of a host, which may be an embodiment of the host of FIG. 10, per various aspects described herein.

FIG. 14 is a block diagram illustrating a virtualization environment in which functions implemented by some embodiments may be virtualized.

FIG. 15 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Network Resource Allocation Overview

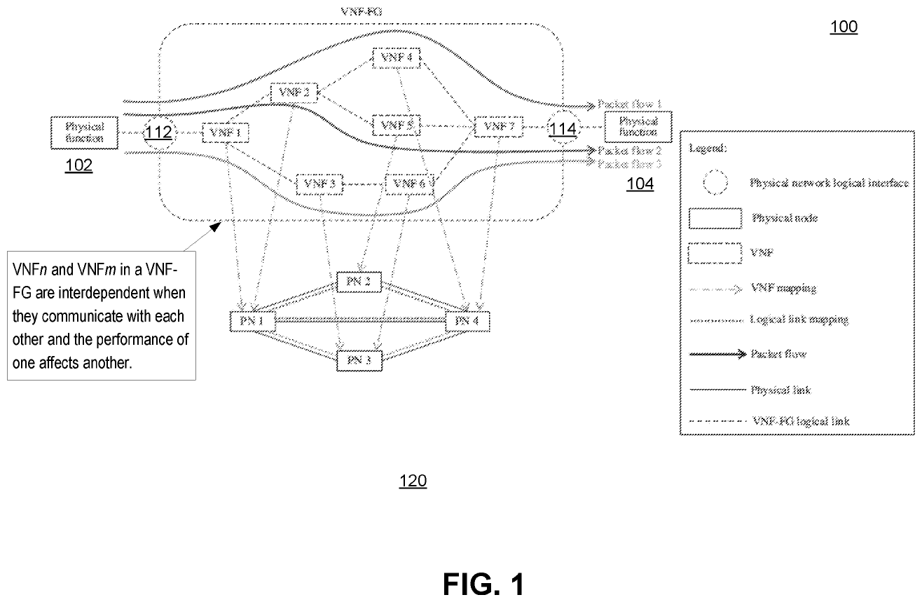

FIG. 1 illustrates service interdependency in a service topology. Network 100 includes a Virtual Network Function-Forwarding Graph (VNF-FG) and physical function 102 and 104. The physical functions interact with the VNF-FG through an entrance physical network logical interface 112 and an exit physical network logical interface 114. The VNF-FG includes seven VNFs (VNF 1-VNF 7), and they are implemented in four physical nodes (PN 1 to PN 4). Packets are forwarded through traffic flows, which are processed through the VNFs. A traffic flow may be identified by a set of attributes embedded to one or more packets of the traffic flow. An exemplary set of attributes includes a 5-tuple (source and destination IP addresses, a protocol type, source and destination TCP/UDP ports). Traffic flows 1 to 3 are transmitted through the VNF-FG via logical links between VNFs. A logical link may be between two VNFs implemented within a single physical node, e.g., the logical link between VNF 1 and VNF 2. These VNFs may share the same resources of the underlying physical node and the performance of one may affect the other. Additionally, when VNF 1 experiences performance degradation, it affects the performance of VNF 2 and VNF 3, which are the downstream VNFs for processing traffic flows 1 to 3. When VNF n and VNF m in a VNF-FG communicate with each other and the performance of one affects the other, VNF n and VNF m are referred to as interdependent VNFs. Note that the terms of “interdependency” and “dependency” and the like are used interchangeably herein when they are used to describe the relationship between services (VNFs or microservices) of a service topology.

In cloud computing, when microservice n and microservice m in a microservice dependency graph communicate with each other and the performance of one affects the other, they are referred to as interdependent microservices. While embodiments of the invention are often explained with VNF-FGs and VNF interdependency, they are applicable to microservice dependency graphs and microservice interdependency as well. Additionally, a service topology herein may refer to either a VNF-FG or a microservice dependency graph, and a service may refer to either a VNF within a VNF-FG or a microservice within a microservice dependency graph.

It is challenging to allocate network resources to various services in a service topology to satisfy performance targets. The service topology can be further complicated with one service chain being split into two or vice versa dynamically. Additionally, these services in the service topology are often interdependent. Furthermore, the services are applied to various user cases, and optimizing network resources for one set of performance targets may result in violation of a different set of performance targets. Several network resource allocation approaches have been proposed, and they may be categorized as the following, using VNFs as examples:

Profiling-based VNF resource allocation: For example, network resource allocation may start with profiling stand-alone VNFs. One may take all different workload and resource configurations into account to profile a VNF, and one experience shows that 5,400 different configurations are tested for the VNF, taking 45 hours. The stand-alone VNF profiling may use a sampling heuristic to help in selecting workload and resource configuration to test. The stand-alone VNF profiling may then be used to estimate the performance of a VNF chain including the stand-alone VNFs; and the performance model of the VNF chain may be adjusted using online monitored data of the VNF chain and the estimated performance.

Machine-learning (ML) based VNF resource allocation: One may estimate VNFs' needs in terms of central/graphics processing unit (CPU/GPU) as a function of the traffic the VNFs will process using the Support Vector Regression (SVR) based approach. Alternatively, the future traffic demand of VNFs may be predicted using ML, and the VNF resources may then be scaled proactively and dynamically. Additionally, one may consider a service function chain (SFC) when predicting VNF resource allocation using ML, where at each VNF, the resource information of all other VNFs in the SFC is also collected.

Reinforcement learning (RL) based resource allocation: One may implement either a single-agent or multi-agent reinforcement learning for resource allocation in the cloud. One approach implements a multi-agent model using Q-learning to optimize resource allocation in the cloud with the aim to improve fault tolerance, energy consumption, and load balancing. However, the approach considers independent tasks of an application without explicitly assuming a graph with dependencies and relationships between application components. An alternative approach considers the interdependency between VNFs when the goal is to predict the future scaling decision, but not to determine resource allocation for current traffic flows. Additionally, that approach do not provide the details of how the interdependency between VNFs is factored and it offers online solution without offline training ahead of time to train the RL models.

These network resource allocation approaches are insufficient to automatically allocate network resources based on a service topology and performance targets: (a) existing approaches often fail to consider the interdependency between services when performing network resource allocation; (b) existing approaches often rely on profiling (e.g., profiling-based VNF resource allocation above) that consider all possible allocation configurations to generate the network resource allocation for the expected performance targets, and the profiling time can be excruciatingly long for real-time traffic flow processing; (d) the existing machine learning based approaches rely heavily on existing training data, which is not always available, and they often ignore the interdependency between services in a service topology; and (e) the existing reinforcement learning based approaches consider generating resource configuration for a specific application/service topology with a specific performance requirement given as input and they do not generalize their solutions to generate a resource configuration for another application with another performance target; and (f) the existing approaches based on machine learning or reinforcement learning perform learning through online learning by iteratively collecting experience by interacting with the environment; yet this sort of online interaction can be impractical either because data collection is expensive or dangerous; and even when the online interaction is feasible, offline learning is still preferable if the environment is complex and effective generalization requires large datasets.

### Markov Decision Process Modeling

Embodiments of the invention implement an approach that automatically generates resource allocation for workloads. The approach may map the performance specification in a service level agreement (SLA) to the amount of resources in a system (e.g., a cloud or network infrastructure) to ensure (1) efficient usage of the resources and (2) meeting the performance specification of an application represented by a service topology.

The resources to be allocated include resources available in a network and/or cloud system, including execution resources (e.g., central processing unit (CPU) or graphics processing unit (GPU)), memory resources, storage space, and the bandwidth to be used to perform services in service topologies.

The approach may generate resource allocation for a service topology with arbitrary performance specification, even for one that it did not encounter during its training phase. The resource allocation is achieved through training models with different performance targets and applications represented in service topologies offline first, and then apply the offline models and adjust them for online resource allocation.

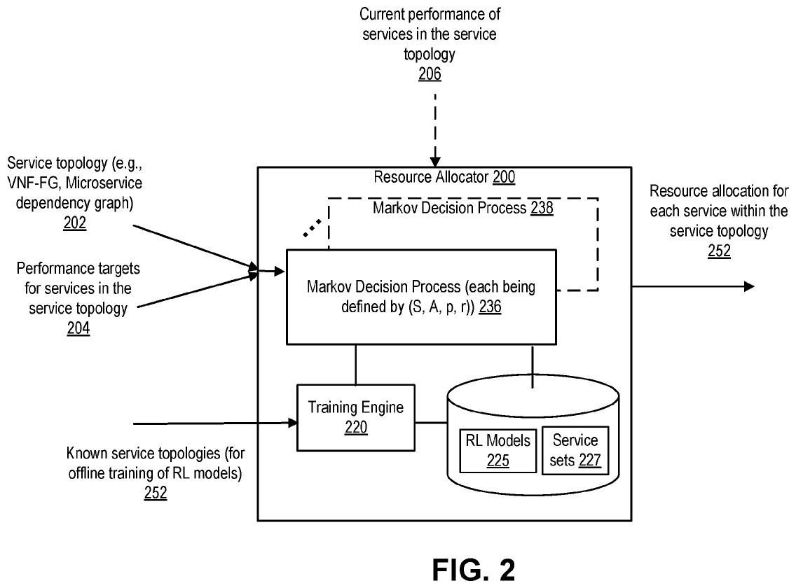

FIG. 2 illustrates resource allocation based on Markov Decision Processes per some embodiments. A resource allocator 200 may be implemented in an electronic device as a hardware circuitry or a software module and it allocates resources for any input service topology.

During online resource allocation, the input to the resource allocator 200 may include (1) a service topology (which indicates the dependency relationship between the services within the service topology) at reference 202, (2) the performance targets for the services within the service topology at reference 204, and (3) the current performance of the services in the service topology at reference 206.

The performance targets for the services may include at least one performance target for each service, and it can be (1) workload metrics such as the number of requests or the number of subscribers that a VNF/microservice (collectively referred to as service volume of a service) must support and/or (2) expected or target performance metrics such as latency or throughput. In some embodiments, the input includes a performance specification in a service level agreement (SLA) for the service topology instead, and the resource allocator 200 converts the server topology level performance specification to the performance target for each service, based on the dependency of the services and expected packet processing at each service in the service topology.

The current performance of the services includes measurements of the corresponding workload metrics or performance metrics of the services at the present time, without allocating resources for the input service topology presented to the resource allocator 200.

In some embodiments, when the resource allocator 200 collects the current performance of the services in the service topology by itself, it does not need to be provided with the current performance of the services in the service topology as an input. Additionally, the resource allocator 200 is assumed to know the current resource allocation and available resources to be allocated for the input service topology, and it will take an additional input to get the current resource allocation and available resources otherwise.

The resource allocator 200 identifies the amount of resources needed to accommodate the services within service topology, and provides an output of resource allocation for each service within the service topology at reference 252. This may be done by taking into consideration the dependencies between the services in a service topology, the performance targets, and the heterogeneity of the current infrastructures (e.g., CPU servers and GPU (graphics processing unit) accelerators).

The resource allocator 200 models the decision-making problem as a set of cooperating Markov Decision Processes (MDPs) and adopts Reinforcement Learning (RL) to solve the MDPs by training an RL agent on the MDP models to generate a model that maps the performance target to resource amount. A “set,” as used herein, refers to any positive whole number of items including one item.

In some embodiments, the set of MDPs may also be referred to as stochastic games or Markov Games, where each agent has its own set of actions. The embodiments of the invention cover the stochastic games or Markov Games as well. For example, the set of MDPs may be one MDP modeled by one agent, and its set of actions captures the resource allocation for the input.

An MDP is defined by a tuple (S, A, p, r) where S is a finite set of states, A is a finite set of actions, p is a transition probability from state s to state s′ after action a is executed, and r is the immediate reward obtained after action a is performed. We denote x as a “policy” which is a mapping from a state to action. The goal of an MDP is to find an optimal policy by training agents (e.g., reinforcement agents discussed herein) to observe the state of the environment and take actions to ultimately maximize the reward function. Of the tuple (S, A, p, r), the transition probability p may be referred to probability space represented by all the probability transitions within the MDP. The probability space depends on the state and action spaces, while the state space, the action space, and the reward function may be defined as follows, using VNFs as examples:

A). State Space: considering we have n VNFs in a VNF-FG, in one embodiment, the state space can be composed of the current resources allocation (res) of each VNF, the current performance of each VNF (p), and the dependency relationship with other VNFs in the VNF-FG, represented by (d). The state then can be represented by:

$$state = \{ 〈 {res}_{1} , {p}_{1} , {d}_{11} , {d}_{12} , … , {d}_{1 n} 〉 , 〈 {res}_{2} , {p}_{2} , {d}_{21} , {d}_{22} , … , {d}_{2 n} 〉 , … , 〈 {res}_{n} , {p}_{n} , {d}_{n 1} , {d}_{n 2} , … , {d}_{nn} 〉 \} \qquad ( 1 )$$

B). Action Space: selecting an action means selecting or changing a resource configuration for VNFs and moving the system to a new state space. In one embodiment, an action can indicate increasing/decreasing a resource of a VNF by x % with predefined minimum and maximum values, or not changing the resource value. The allowable range of increasing/decreasing is the action list in the action space. Each action causes the state to change to a new state. For the above embodiment, we can have a joint action, which is composed of the actions to be applied to each VNF in the VNF-FG:

$$A = [ a\_ 1 , a\_ 2 , … a\_n ] \qquad ( 2 )$$

C). Reward Function: the reward function is used to guide the RL agent(s) to find the optimal resource configuration. In one embodiment that is detailed below, the reward is calculated in terms of the selected resource configuration and the given performance target, which can be seen as the objective function. The performance target part can be optimizing service latency, resource consumption, supported service volume, supported throughput, or packet loss, for instance. The action leading to a better objective function is associated with a larger reward. In reinforcement learning, the long-term cumulative reward is the optimization target of the reinforcement learning. And the immediate rewards are the VNFs performance feedback on the resulted new resource configuration. The performance of individual VNF is measured by a score. In one embodiment, the score may be calculated by the following:

$${Score}_{vnfi} = - {perf}_{price} - penalty \qquad ( 3 )$$

$$Where ,$$

$${perf}_{price} = \{ \begin{matrix}K 1 * perf & if perf < 0 \\ K 2 * perf & else\end{matrix} \} \qquad ( 4 )$$

The notation of “price” implies the corresponding monetary cost (“money”) a service would incur (e.g., the user of such service would be willing to pay) to obtain a certain performance. And,

$$K 1 = - ∞ ( or very small number ) , K 2 = 0 ( or close to zero ) . \qquad ( 5 )$$

If the goal is to minimize a performance measurement, e.g., response time, then:

$$perf = \frac{{target}_{perf} - {current}_{perf}}{{target}_{perf}} \qquad ( 6 )$$

If the goal is to maximize a performance measurement, e.g., throughput, then:

$$perf = \frac{{current}_{perf} - {target}_{perf}}{{target}_{perf}} \qquad ( 7 )$$

Note that variables K1 being −∞ (or very small number) and K2 being zero (or close to zero) above are examples of their values. K1 being −∞ means that we are willing to pay any amount to get the performance at least on target, i.e., perf=0 (when the perf <0). K2 represents the cost of extra performance in some embodiments and it being zero means that we don't care about any performance above zero (not willing to pay for extra performance). To have some ‘slope’ to indicate the gradient of decent, we do not want to keep K1 at −∞; rather, K1 may be set to be very small (with large magnitude). Also, care should be taken when assigning K2 to a non-zero value. If K2 is less than the slope of the penalty, it has no effect, and the score is maximized when the performance is on target. If it is above the slope of the penalty, then it will be maximized when the resource allocation reaches the maximum available resource. Ideally, K2 itself should be a function that increases with increasing performance.

Perf=0 represents the performance is on target, while Perf=1 represents the performance is twice the performance target and Perf=2 represents three times the performance target.

Penalty reflects the cost of assigned resource, e.g.,

$$Penalty = {cost}_{resource} \qquad ( 8 )$$

The reward for each VNF may then be calculated as the following:

$${r}_{vnfi} = α * {score}_{vnfi} + β {\sum }_{∀ j ∈ {dependents}_{i}} {score}_{vnfi} \qquad ( 9 )$$

where dependents; indicate the VNFs in the VNF-FG that the current vnfᵢ depends on.

Formulas (1) to (9) characterize the variables of one MDP. For some of the variables, their values are provided by the input or data collected by the resource allocator 200, such as the dependency between VNFs, the performance targets, available resources; yet other variables characterize the MDP, such as the score and related perf, penalty, and reward, and their values need to be provided by training a set of reinforcement learning models for the MDP.

The allocated resources for the input service topology are then provided to the input service topology so that each service may obtain the allocated resources, and these services then serve the corresponding traffic flows (e.g., traffic flows 1 to 3), and given the resources are allocated per performance targets of these services, these service now may provide the targeted performance and processing packets of the input traffic flows.

For the training, the resource allocator 200 includes a training engine 220, which trains to produce a set of models for the set of MDPs 236 to 238, using the input of known service topologies at reference 252. Such training may be performed offline prior to the resource allocator 200 allocating resources for the input service topology at reference 202 and performance targets at reference 204. In some embodiments, the training is through reinforcement learning (RL), and trained models are RL models 225 and corresponding service sets 227 used for training the RL models are stored in a datastore, which may be implemented in one of a variety of databases (e.g., relational database, mongo database, Hadoop database). The RL models 225 and the service sets 227 are then used by the set of MDPs 236 to 238. The training is explained in further detail herein below.

### Training Based on Reinforcement Learning

Reinforcement learning is a type of machine learning to train one or more intelligent agents (also referred to simply as agents) to take actions in an environment to maximize a cumulative reward. Reinforcement learning emphasizes on finding a balance between exploration (of uncharted territory) and exploitation (of current knowledge). The environment of reinforcement learning includes the state space of an MDP. The reinforcement learning may be formed to train a single agent or a team of collaborating agents, the latter of which may be referred to as multi-agent reinforcement learning (MARL).

In some embodiments, a single agent may be used to train a ML model for the MDP to allocate resources for a service topology. In training, the single agent considers the states of each service in known service topologies and takes actions on each service of the service topologies, with the goal of maximizing a cumulative reward (e.g., the sum of rewards for each VNF calculated using Formula (9)) based on the performance targets.

Alternatively, multi-agent reinforcement learning (MARL) may be used to train a team of agents to collaborate to maximize a global reward based on local and remote observations to build a reinforcement learning model. MARL may leverage parallel computation and the system can have a high degree of scalability. For example, when the service topologies are VNF-FGs, each agent within MARL may be associated with a VNF. This allows the embodiments to train a VNF agent that understands the resource need of the VNF during the training. This also allows the embodiments to deal with a new VNF-FG that were not encountered during the training.

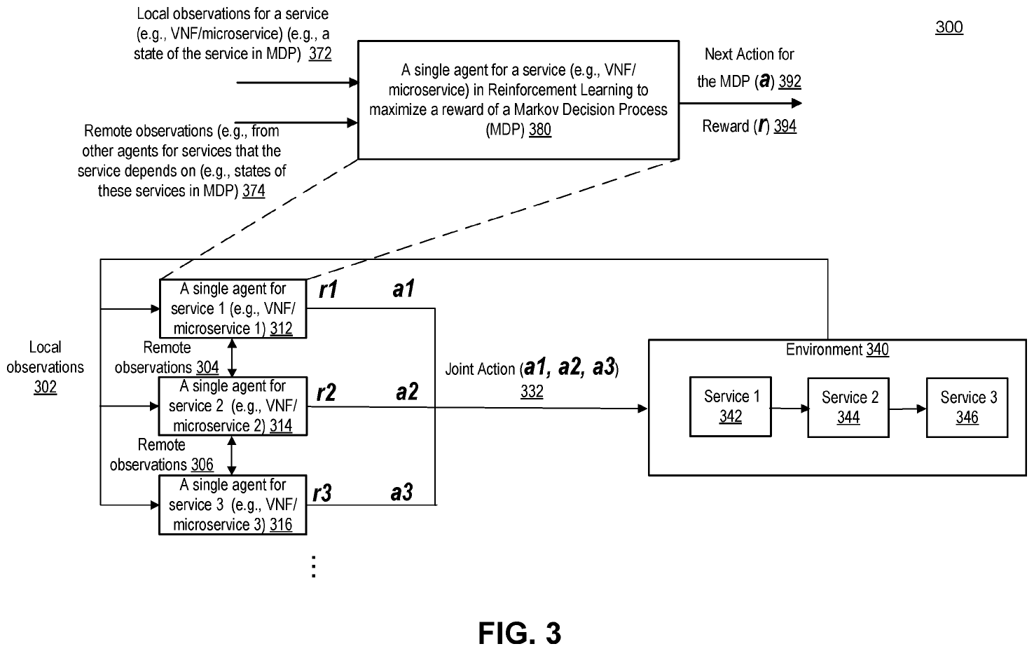

FIG. 3 illustrates multi-agent reinforcement learning (MARL) for resource allocation per some embodiments. In some embodiments, the illustrated system 300 is implemented in the training engine 220 with multiple collaborating agents trained for a common goal. The example shows agents such as three single agents 312 to 316 to take input from environment 340 that includes states of services 1 to 3 at references 342 to 346 for the training. Each agent responsible for one VNF (or a microservice) and taking an action that affects the VNF's (or microservice's) resources and performance it is responsible for.

A single agent for a service 380 takes as input its local observation 372 (e.g., the state of a VNF such as <res₁, p₁, d₁₁, d₁₂, . . . , dᵢₙ> for VNF 1 of a VNF-FG) and remote observations 374 that may be from other agents for services that the service depends on (e.g., the state of other VNFs of the VNF-FG such as <res₂, p₂, d₂₁, d₂₂, . . . , d₂ₙ>, . . . , <resₙ, pₙ, dₙ₁, dₙ₂, . . . , dₙₙ>). The local observations are collected from its corresponding service and the remote observations are collected from the agents of services that the current service depends on. The agent then calculates a reward function 394 and applies an action 392 that maximizes its reward according to the local and remote observations. The reward function reflects the performance of the services that the given service depends on. Accordingly, each agent generates the next action to be applied to the corresponding service in the environment. The actions form a joint action (a1, a2, and a3) at reference 332 (the joint action represents the action space of a MDP as shown at Formula (2)). The agents are trained to derive the optimal variable values for the corresponding MDP to achieve best resource allocation, at a given condition (e.g., within a given time or a given number of iterations of the training, and within an acceptable reward value) to terminate the training.

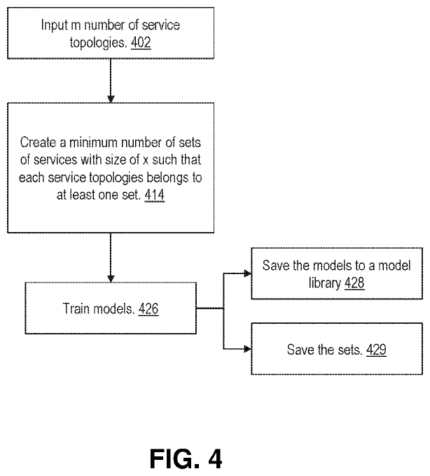

FIG. 4 is a flow diagram illustrating the operations to generate reinforcement models that provide resource allocation for service topologies with different dependencies per some embodiments. The operations are performed by the resource allocator 200 discussed herein above.

At reference 402, m number of service topologies (e.g., 1,000 VNF-FGs) are taken as input. Each service topology indicates service interdependencies within as discussed. At reference 414, a minimum number of sets of services are created. A set of services is an unordered collection of services with no duplicate elements to prevent duplicate services from being added to the set. The creation may limit each set with x services at the maximum (predefined size), such that each of the service topologies in the m service topologies belong to at least one set. Thus, all the services making up a service topology within the service topologies belong to at least one set.

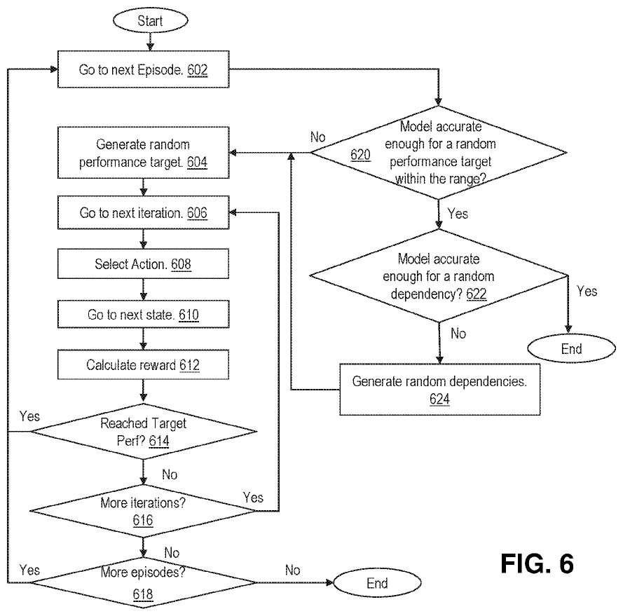

At reference 426, the sets are used as input to train RL models for corresponding MDPs. The training of RL models is explained in further details herein below. At reference 428, the trained models are saved to a model library (e.g., RL models 225); and at reference 429, the service sets along with their dependencies are saved to a repository (e.g., service sets 227). The information about the services dependencies is used later to guide random dependency generation (discussed in more details at FIG. 6). These sets will be used when a service topology comes to match its services with the services in each set and decide which model to use accordingly.

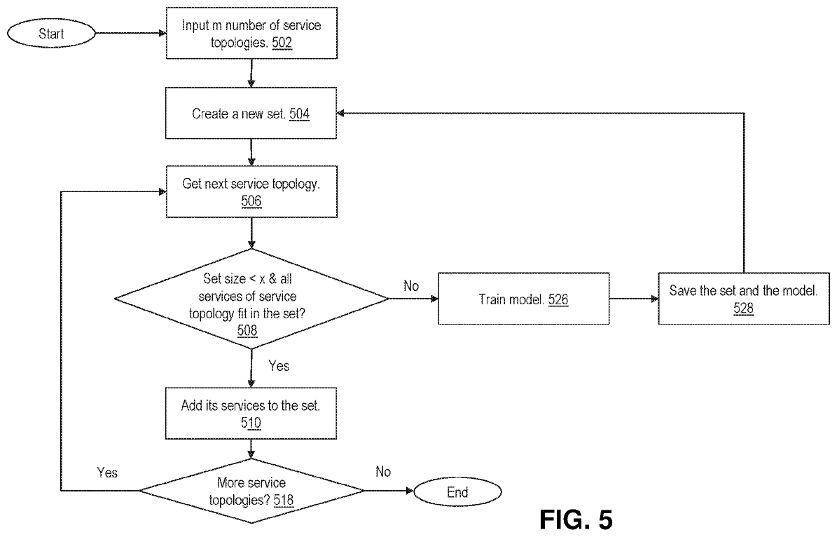

FIG. 5 is a flow diagram illustrating the operations to create the minimum number of sets of services per some embodiments. The operations of FIG. 5 are one embodiment to implement the operations of FIG. 4. At reference 502, m number of service topologies are taken as input. Each service topology indicates service interdependencies within as discussed. At reference 504, a new set is created. The new set has a size x to fill it with services that comprise the service topologies. Once all services in an existing service topology are included, the flow goes to reference 506 to get the next service topology of the m number of service topologies.

At reference 508, it is determined whether the created set is within its set limit, and if it is, and whether all the services of the next service topology fit in the set. If both conditions are met, the services of the next service topology are added to the set at reference 510. If no more service topologies are available for training as determined at reference 518, the flow ends; the flow goes back to reference 506 otherwise.

If either condition is not met, a RI, model is trained for the services in the set. The flow goes to reference 526 to train a corresponding RL model (similar to reference 426) and the resulting sets and RL model are saved at reference 528 (similar to reference 428 and 429).

With that, each model will be able to generate a resource allocation for the given m service topologies. Note that the training at references 426 and 526 for different sets may be done in parallel thus provide further offline training efficiency.

FIG. 6 is a flow diagram illustrating the operations to a reinforcement agent to automatically generate resource allocation for any performance target per some embodiments. The operations are performed by the resource allocator 200 discussed herein above. Each of the reinforcement learning agents may be one of agents 312 to 316 in some embodiments. The reinforcement agent may train a reinforcement learning model for a set of services within service sets (e.g., the operations at references 426 and 526) or a set of service within a service topology. These embodiments define a number of episodes to train the agent for allocate resources for the set of services (e.g., the set of service trained at references 426 and 526). An episode includes a sequence of states, actions, and rewards in a Markov Decision Process, and the sequence of state includes all the states that come in between an initial state and a terminal state. The following uses training VNFs within a VNF-FG as an example.

The operations start at getting to the next episode at reference 602. At reference 620, it determines whether an existing model for the service set is accurate enough for a random performance target within a realistic range for the given service. The performance target of a service may be set in a wider range when values of the corresponding performance metric may vary widely (e.g., latency can vary from microseconds to seconds and still be acceptable to many services, but not in minutes, and the realistic may be set to be between 10 ns to 2 seconds), yet it may be set to a narrower range for other performance metric (e.g., the realistic range for the throughput of an audio service may be set to be between 0.1˜3 M bps).

If the existing model is not accurate enough, the flow goes to reference 604, where the agent generates a random performance target. This is the expected performance of the application or the representative VNF-FG. The expected performance can be defined randomly within the realistic range (which may be pre-specified).

The training may define a number of iterations inside each episode. Each iteration represents a frame within the episode. At reference 606, the flow goes to the next iteration when the iteration number has not exhausted.

At reference 608, an action is selected for each VNF in the VNF-FG. The action is selected from an action list, discussed herein above relating to Formula (2). An action may indicate to change the resources amount of a VNF (e.g., reduce the current resources by 50%) We consider constrained actions, meaning that a resource amount of a VNF cannot be increased over a specified threshold. This indicates the maximum allowed resources for a VNF and can be given as input.

The selection of the action to allocate resources can be done using different policies. In some embodiments, a greedy policy may be implemented. The policy consists of exploration and exploitation. The greedy policy, referred to as Epsilon-Greedy policy, may be defined as follows: (i) with probability epsilon, we select a random action a; and (ii) with probability 1-epsilon, we select an action that has a maximum value.

After selecting an action and applying it to the environment (that includes other VNFs of the VNF-FG, shown in environment 340 including services 342 to 346), the flow moves to a new state at reference 610. As discussed herein above, the state of a VNF indicates the current resources configuration of the VNF, the current performance of the VNF, and the inter-dependencies between VNFs (e.g., a local observation in FIG. 3).

The reward is then calculated at reference 612. The reward may be calculated based on Formula (9) in some embodiments. At reference 614, it is determined whether the performance, as measured by the reward, is sufficient for the performance target. When it is, the episode is complete, and the flow returns to reference 602. When the performance is insufficient, the flow goes to reference 616 to check whether more iterations are available.

When the iterations of the episode have not been exhausted yet, the flow returns to reference 604; the flow otherwise goes to reference 618 to check whether more episodes are available—if so, the flow goes back to reference 602, otherwise the process ends without training a successful model.

Return to reference 620, if it is determined that the model for the service set is accurate enough for a random performance target within the realistic range for the given service, the flow goes to reference 622 (instead of reference 604 when the determination is negative), where it is determined whether the model is accurate enough for any random dependency between the VNF and other VNFs of the VNF-FG.

If the model is not accurate enough for any random dependency, then a new random dependency is generated at reference 624. The generation of the dependencies is done such that the original dependencies defined in the VNF-FGs are prioritized by giving higher probability, while lower probability is given for dependencies that are not in the VNF-FGs. If it is accurate enough, then the process ends with a success, and the resulting model is saved for the agent.

Note the order of some operations may be swappable. For example, the model may be trained for a specific performance target considering different dependencies; and once the model is accurate enough for any dependencies, a new random performance target is generated to continue training the model.

In some embodiments, the agent is trained along with other agents in MARL, so that collaboratively they may generate the models, and the characteristics of services (VNFs/microservices) in a service topology (VNF-FG or microservice dependency graph) are captured by the models. The model may then provide values of variables for the corresponding MDPs to allocate resources for the service topologies.

Note that the learning discussed in this section is done in an offline manner. The trained RL models are trained for specific number of service topologies.

### Online Operations for Input Service Topology Per Some Embodiments

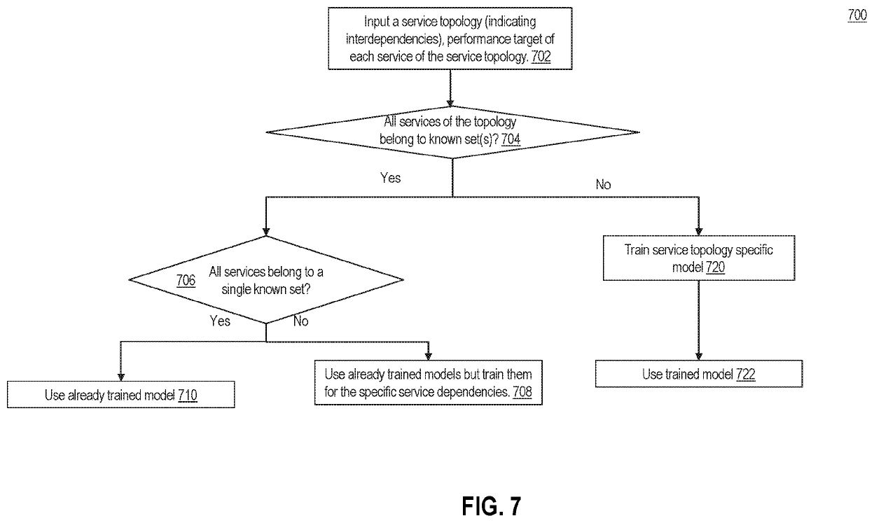

Once the models are trained and saved in a resource allocator, the resource allocator is ready to take service topology as input and provides resource allocation. FIG. 7 is a flow diagram illustrating the operations to identify a model to use for a service topology per some embodiments. The operations are performed by the resource allocator 200 discussed herein above.

At reference 702, the resource allocator receives, as input, (1) a service topology that indicates interdependencies of the services, and (2) a performance target of each service of the service topology. At reference 704, the resource allocator determines whether all the services of the service topology belong to the known sets. The known sets are saved in offline training (e.g., at references 429 and 528) in service sets 227.

If all the services belong to the known sets, the flow goes to reference 706, where it is determined whether all the services belong to a single set. If it belongs to a single set, then the service topology may use the corresponding RL model for the single set at reference 710. In this case, the characteristics of the services in the service topology are captured by the model, which provides values of variables for the corresponding MDPs to allocate resources for the service topology at the required performance targets for its services.

If the services belong to multiple known sets, the corresponding multiple known models may still be used for the service topology, but these known models are trained at reference 708 for the specific dependencies of the services (e.g., for the services between two known sets). The retrained model can then be used for the service topology, and the retrained model are then saved in RL models 225, along with the corresponding services as a service set at service sets 227.

If one or more services do not belong to the known sets, the flow goes to reference 720, and the resource allocation model may train RL models for the new service topology, the training may be performed similarly as shown in FIGS. 4 to 6 but perhaps with less iterations, considering the online nature of the training. The trained model is then used at reference 722 for the service topology.

Note that offline learning provides efficiency by shortening or eliminating the online training (at reference 708 or 710, respectively), so that online training is done only for services that have not encountered from the service topologies in the training phase.

### Operations Per Some Embodiments

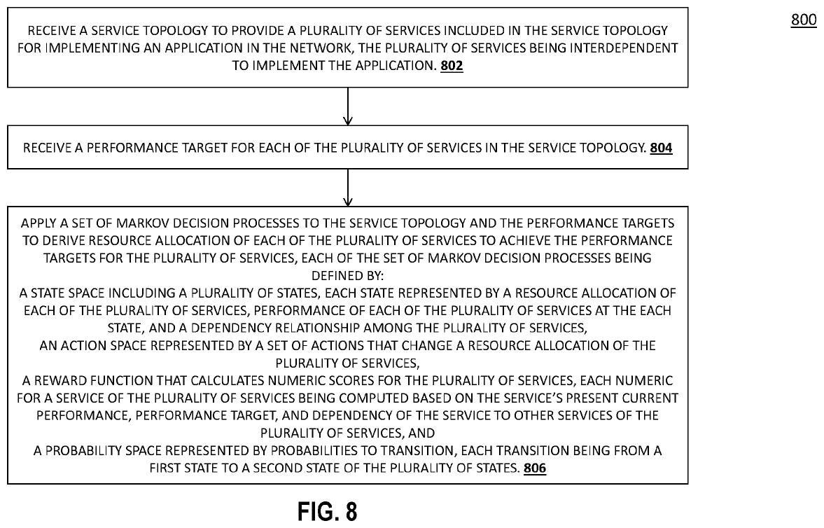

FIG. 8 is a flow diagram illustrating the operations to provide resource allocation for a service topology per some embodiments. The operations are performed by the resource allocator 200 discussed herein above.

At reference 802, a service topology is received to provide a plurality of services included in the service topology for implementing an application in a network, the plurality of services being interdependent to implement the application. At reference 804, a performance target is received for each of the plurality of services in the service topology.

At reference 808, a set of Markov Decision Processes is applied to the service topology and the performance targets to derive resource allocation of each of the plurality of services to achieve the performance targets for the plurality of services. Each of the set of Markov Decision Processes is defined by: (a) a state space including a plurality of states, each state represented by a resource allocation of each of the plurality of services, performance of each of the plurality of services at the each state, and a dependency relationship among the plurality of services; (b) an action space represented by a set of actions that change a resource allocation of the plurality of services; (c) a reward function that calculates numeric scores for the plurality of services, each numeric score for a service of the plurality of services being computed based on the service's current performance, performance target, and dependency of the service to other services of the plurality of services, and (d) a probability space represented by probabilities to transition, each transition being from a first state to a second state of the plurality of states.

The definition of a Markov Decision Process (MDP) is discussed herein above relating to Formula (1) to (9). In some embodiments, each of the plurality of services comprises a virtual network function (VNF), and where the service topology comprises a VNF forward graph (VNF-FG). Alternatively, each of the plurality of services comprises a microservice, and wherein the service topology comprises a microservice dependency graph.

In some embodiments, the performance target for each of the plurality of services comprises one or more of a service latency, a resource consumption, a supported service volume, and a supported throughput.

In some embodiments, the set of Markov Decision Processes are trained using reinforcement machine learning prior to the set of Markov Decision Processes is applied to service topology and the performance targets. In some embodiments, the training results in a plurality of reinforcement machine learning models, each reinforcement machine learning model mapping to a set of services and corresponding resource allocation for the set of services. The offline training is discussed herein above relating to FIGS. 4 to 6.

In some embodiments, applying the set of Markov Decision Processes to the service topology and the performance targets to derive resource allocation of each of the plurality of services comprises matching the plurality of services included in the service topology to the plurality of reinforcement machine learning models and sets of services and corresponding resource allocations for the sets of services.

In some embodiments, when characteristics of the plurality of services included in the service topology have been captured by a single reinforcement machine learning model within the plurality of reinforcement machine learning models, the single reinforcement machine learning model is used to apply a corresponding Markov Decision Process to derive resource allocation of each of the plurality of services. When the characteristics of the plurality of services included in the service topology have been captured by multiple reinforcement machine learning models, the multiple reinforcement machine learning models are trained again based on dependency of the plurality of services to derive resource allocation of each of the plurality of services.

In some embodiments, when characteristics of at least one of the plurality of services included in the service topology have not been captured by the plurality of reinforcement machine learning models, a new reinforcement machine learning model is trained based on the plurality of services included in the service topology. These training are discussed in further details herein above relating to FIG. 7.

In some embodiments, multi-agent reinforcement learning is performed to produce the plurality of reinforcement machine learning models, one agent of the multi-agent reinforcement learning model being responsible for one service.

In some embodiments, an agent of the multi-agent reinforcement learning model is trained using multiple known service topologies to provide corresponding services.

In some embodiments, the agent of the multi-agent reinforcement learning model is trained for the corresponding services to achieve a set of criteria within a number of iterations. For example, the set of criteria include one or more of (1) achieving a set of dependencies and (2) achieving a set of performance targets as discussed herein above relating to FIG. 7.

Through embodiments of the invention, a set of MDPs is used to (1) model a problem of resource allocation for a service topology and (2) describe the environment of the problem. The environment can be described by a single MDP or group of MDPs (collectively referred to as a set of MDPs). Accordingly, reinforcement learning modeling may train a set of single agent models and generate resource allocation for the services in the service topology following the single MDP, or it may train a set of multi-agent reinforcement learning (MARL) models each including multiple agents, each agent for one MDP within the group of MDPs. In both cases, the identified variable values from the reinforcement learning models are used in the set of MDPs to allocate resources for an input service topology.

These embodiments of the invention provide an automated solution to generate resource allocation for an input of services in a service topology. They can handle applications implemented through the service topology with any performance targets as given. They provide generic solution that can generate a resource allocation for various expected/target performances and for large number of service topologies with various interdependencies between services. Additionally, the embodiments may be applied to assist in the optimal placement and performance of service topologies. For example, the placement process comes after generating the resources allocation of services of a service topology. After finding the optimal resources to be allocated to services, then the placement solution will place these services with the identified resources that are optimal, and this will ensure good performance of these service topology. Furthermore, the embodiments may be applied to an already deployed VNFs when a resource reallocation is needed (e.g., when a network is scaled).

### Devices Implementing Embodiments of the Invention

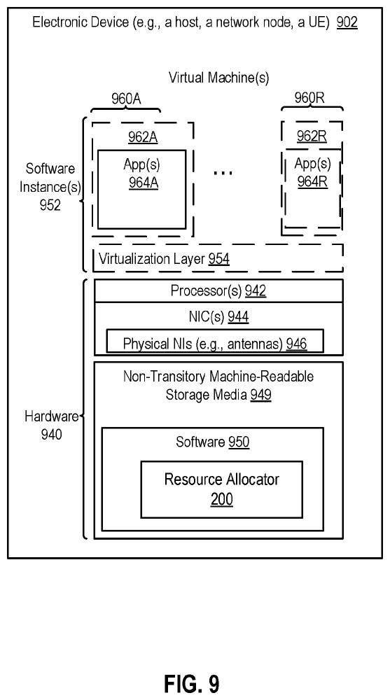

FIG. 9 illustrates an electronic device implementing adaptive fault remediation per some embodiments. The electronic device may be a host in a cloud system, or a network node/UE in a wireless/wireline network, and the operating environment and further embodiments the host, the network node, the UE are discussed in more details herein below. The electronic device 902 may be implemented using custom application-specific integrated-circuits (ASICs) as processors and a special-purpose operating system (OS), or common off-the-shelf (COTS) processors and a standard OS. In some embodiments, the electronic device 902 implements resource allocation 200.

The electronic device 902 includes hardware 940 comprising a set of one or more processors 942 (which are typically COTS processors or processor cores or ASICs) and physical NIs 946, as well as non-transitory machine-readable storage media 949 having stored therein software 950. During operation, the one or more processors 942 may execute the software 950 to instantiate one or more sets of one or more applications 964A-R. While one embodiment does not implement virtualization, alternative embodiments may use different forms of virtualization. For example, in one such alternative embodiment, the virtualization layer 954 represents the kernel of an operating system (or a shim executing on a base operating system) that allows for the creation of multiple instances 962A-R called software containers that may each be used to execute one (or more) of the sets of applications 964A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 954 represents a hypervisor (sometimes referred to as a virtual machine monitor (VMM)) or a hypervisor executing on top of a host operating system, and each of the sets of applications 964A-R run on top of a guest operating system within an instance 962A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 940, directly on a hypervisor (in which case the unikernel is sometimes described as running within a LibOS virtual machine), or in a software container, embodiments can be implemented fully with unikernels running directly on a hypervisor represented by virtualization layer 954, unikernels running within software containers represented by instances 962A-R, or as a combination of unikernels and the above-described techniques (e.g., unikernels and virtual machines both run directly on a hypervisor, unikernels, and sets of applications that are run in different software containers).

The software 950 contains the resource allocation 200 that performs operations described with reference to operations as discussed relating to FIGS. 1 to 8. The resource allocation 200 may be instantiated within the applications 964A-R. The instantiation of the one or more sets of one or more applications 964A-R, as well as virtualization if implemented, are collectively referred to as software instance(s) 952. Each set of applications 964A-R, corresponding virtualization construct (e.g., instance 962A-R) if implemented, and that part of the hardware 940 that executes them (be it hardware dedicated to that execution and/or time slices of hardware temporally shared), forms a separate virtual electronic device 960A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 944. The physical network interface 946 may include one or more antenna of the electronic device 902. An antenna port may or may not correspond to a physical antenna. The antenna comprises one or more radio interfaces.

### A Wireless Network Per Some Embodiments

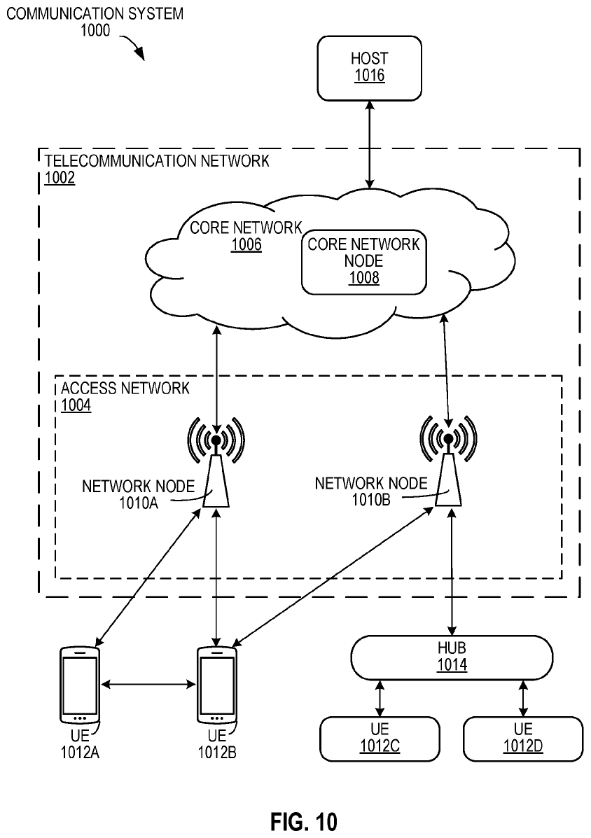

FIG. 10 illustrates an example of a communication system 1000 per some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 10126, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UF over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

### UE Per Some Embodiments

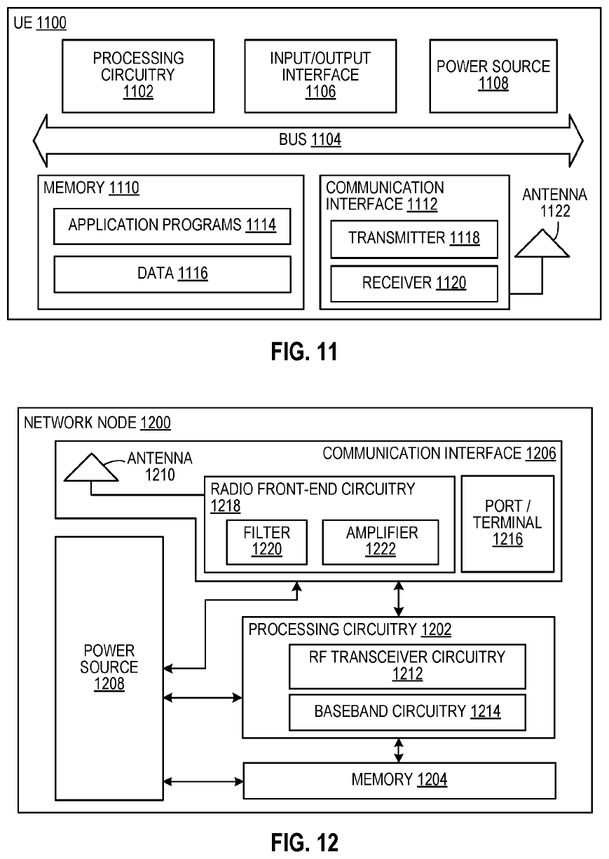

FIG. 11 illustrates a UE 1100 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 12 illustrates a network node 1200 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

### Host Per Some Embodiments

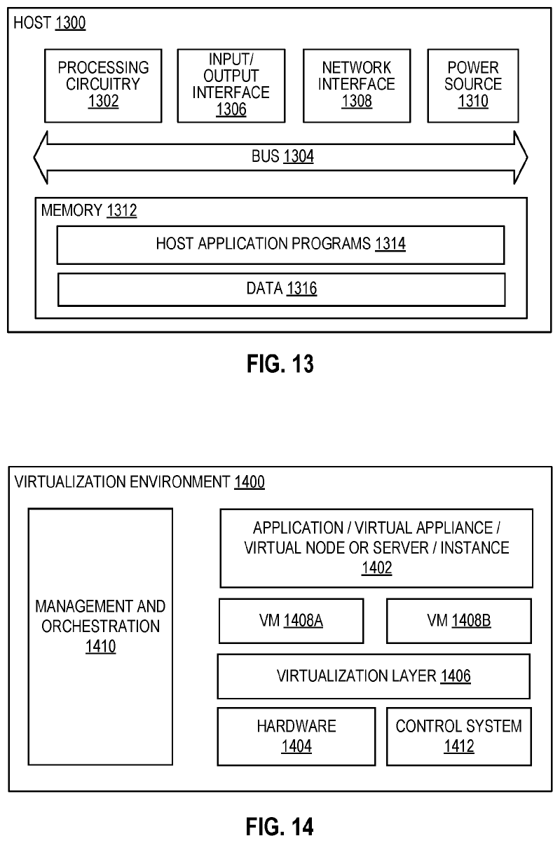

FIG. 13 is a block diagram of a host 1300, which may be an embodiment of the host 1016 of FIG. 10, per various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 13, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

### Communication Among Host, Network Node, and UE Per Some Embodiments

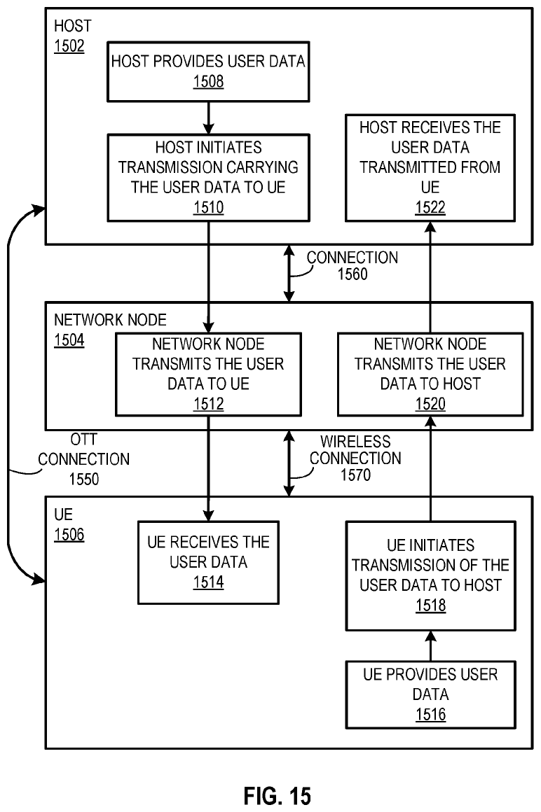

FIG. 15 illustrates a communication diagram of a host 1502 communicating via a network node 1504 with a UE 1506 over a partially wireless connection per some embodiments. Example implementations, in accordance with various embodiments, of the UE (such as a UE 1012a of FIG. 10 and/or UE 1100 of FIG. 11), network node (such as network node 1010a of FIG. 10 and/or network node 1300 of FIG. 13), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UF's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the CE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other.

An electronic device (such as the electronic device 902) stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in an electronic device to allocate resources of a network, comprising:
receiving a service topology to provide a plurality of services included in the service topology for implementing an application in the network, the plurality of services being interdependent to implement the application;
receiving a performance target for each of the plurality of services in the service topology; and
applying a set of Markov Decision Processes to the service topology and the performance targets to derive resource allocation of each of the plurality of services to achieve the performance targets for the plurality of services, each of the set of Markov Decision Processes being defined by:
a state space including a plurality of states, each state represented by a resource allocation of each of the plurality of services, performance of each of the plurality of services at the each state, and a dependency relationship among the plurality of services,
an action space represented by a set of actions that change a resource allocation of the plurality of services,
a reward function that calculates numeric scores for the plurality of services, each numeric score for a service of the plurality of services being computed based on the service's current performance, performance target, and dependency of the service to other services of the plurality of services, and
a probability space represented by probabilities to transition, each transition being from a first state to a second state of the plurality of states.

2. The method of claim 1, wherein each of the plurality of services comprises a virtual network function (VNF), and wherein the service topology comprises a VNF forward graph (VNF-FG).

3. The method of claim 1, wherein each of the plurality of services comprises a microservice, and wherein the service topology comprises a microservice dependency graph.

4. The method of claim 1, wherein the performance target for each of the plurality of services comprises one or more of a service latency, a resource consumption, a supported service volume, and a supported throughput.

5. The method of claim 1, wherein the set of Markov Decision Processes are trained using reinforcement machine learning prior to the set of Markov Decision Processes being applied to service topology and the performance targets.

6. The method of claim 5, wherein the training results in a plurality of reinforcement machine learning models, each reinforcement machine learning model mapping to a set of services and corresponding resource allocation for the set of services.

7. The method of claim 6, wherein applying the set of Markov Decision Processes to the service topology and the performance targets to derive resource allocation of each of the plurality of services comprises:
matching the plurality of services included in the service topology to the plurality of reinforcement machine learning models and sets of services and corresponding resource allocations for the sets of services.

8. The method of claim 7, wherein when characteristics of the plurality of services included in the service topology have been captured by a single reinforcement machine learning model within the plurality of reinforcement machine learning models, using the single reinforcement machine learning model to apply a corresponding Markov Decision Process to derive resource allocation of each of the plurality of services, and wherein when the characteristics of the plurality of services included in the service topology have been captured by multiple reinforcement machine learning models, training the multiple reinforcement machine learning models again based on dependency of the plurality of services to derive resource allocation of each of the plurality of services.

9. The method of claim 7, wherein when characteristics of at least one of the plurality of services included in the service topology have not been captured by the plurality of reinforcement machine learning models, training a new reinforcement machine learning model based on the plurality of services included in the service topology.

10. The method of claim 6, wherein multi-agent reinforcement learning is performed to produce the plurality of reinforcement machine learning models, one agent of the multi-agent reinforcement learning model being responsible for one service.

11. The method of claim 10, wherein an agent of the multi-agent reinforcement learning model is trained using multiple known service topologies to provide corresponding services.

12. The method of claim 11, wherein the agent of the multi-agent reinforcement learning model is trained for the corresponding services to achieve a set of criteria within a number of iterations.

13. An electronic device, comprising:
a processor and non-transitory machine-readable storage medium that provides instructions that, when executed by the processor, are capable of causing the processor to perform:
receiving a service topology to provide a plurality of services included in the service topology for implementing an application in a network, the plurality of services being interdependent to implement the application;
receiving a performance target for each of the plurality of services in the service topology; and
applying a set of Markov Decision Processes to the service topology and the performance targets to derive resource allocation of each of the plurality of services to achieve the performance targets for the plurality of services, each of the set of Markov Decision Processes being defined by:
a state space including a plurality of states, each state represented by a resource allocation of each of the plurality of services, performance of each of the plurality of services at the each state, and a dependency relationship among the plurality of services,
an action space represented by a set of actions that change a resource allocation of the plurality of services,
a reward function that calculates numeric scores for the plurality of services, each numeric score for a service of the plurality of services being computed based on the service's current performance, performance target, and
dependency of the service to other services of the plurality of services, and a probability space represented by probabilities to transition, each transition being from a first state to a second state of the plurality of states.

14. The electronic device of claim 13, wherein each of the plurality of services comprises a virtual network function (VNF), and wherein the service topology comprises a VNF forward graph (VNF-FG).

15. The electronic device of claim 13, wherein each of the plurality of services comprises a microservice, and wherein the service topology comprises a microservice dependency graph.

16. The electronic device of claim 13, wherein the performance target for each of the plurality of services comprises one or more of a service latency, a resource consumption, a supported service volume, and a supported throughput.

17. The electronic device of claim 13, wherein the set of Markov Decision Processes are trained using reinforcement machine learning prior to the set of Markov Decision Processes being applied to service topology and the performance targets.

18.-24. (canceled)

25. A non-transitory machine-readable storage medium that provides instructions that, when executed by a processor, are capable of causing the processor to perform:
receiving a service topology to provide a plurality of services included in the service topology for implementing an application in a network, the plurality of services being interdependent to implement the application;
receiving a performance target for each of the plurality of services in the service topology; and
applying a set of Markov Decision Processes to the service topology and the performance targets to derive resource allocation of each of the plurality of services to achieve the performance targets for the plurality of services, each of the set of Markov Decision Processes being defined by:
a state space including a plurality of states, each state represented by a resource allocation of each of the plurality of services, performance of each of the plurality of services at the each state, and a dependency relationship among the plurality of services,
an action space represented by a set of actions that change a resource allocation of the plurality of services,
a reward function that calculates numeric scores for the plurality of services, each numeric score for a service of the plurality of services being computed based on the service's current performance, performance target, and dependency of the service to other services of the plurality of services, and
a probability space represented by probabilities to transition, each transition being from a first state to a second state of the plurality of states.

26. (canceled)

27. The non-transitory machine-readable storage medium of claim 25, wherein each of the plurality of services comprises a virtual network function (VNF), and wherein the service topology comprises a VNF forward graph (VNF-FG).

28. The non-transitory machine-readable storage medium of claim 25, wherein each of the plurality of services comprises a microservice, and wherein the service topology comprises a microservice dependency graph.
